(19) United States
(12) Patent Application Publication
(10) Pub. No.: US 2002/0191651 A1
(43) Pub. Date: Dec. 19, 2002

(54) Tunable laser source, and method for preventing occurrence of mode hopping phenomenon in tunable laser source

(76) Inventor: Seiji Funakawa, Tokyo (JP)

Correspondence Address: SAMUEL BORODACH, Fish & Richardson P.C., Suite 2800, 45 Rockefeller Plaza, New York, NY, 10111, US

(21) Appl. No.: 10/170,754

(22) Filed: Jun. 13, 2002

(30) Foreign Application Priority Data
Jun. 14, 2001 (JP) P. 2001-179461

(51) Int. Cl. H01S 3/10

(52) U.S. Cl. 372/20

(57) ABSTRACT

A tunable laser source for continually changing the wavelength of output light by means of changing the length of an external cavity of an external cavity-type semiconductor laser light source section includes laser diode current control section 7, 8 for controlling a drive current supplied to a laser diode 1 as section for changing the length of the external cavity for preventing occurrence of mode hopping which arises as a result of continual changes in the wavelength of output light.

### BACKGROUND OF THE INVENTION

The present invention relates to a tunable laser source capable of continually changing the wavelength of output light to be used for evaluating or manufacturing an optical communications system or a device, as well as to a method of preventing occurrence of mode hopping in a tunable laser source.

A related-art tunable laser source will be described in detail by reference to FIG. 3.

FIG. 3 shows the detailed configuration of a tunable laser source. An external oscillator-type semiconductor laser light source is constituted of a laser diode (LD) 21; lenses 22a, 22b; a diffraction grating 23; a mirror 24; and a servomotor 25.

Light output from the laser diode 21 is converted into collimated light by means of the lens 22a, and the thus-collimated light enters the diffraction grating 23.

Of the light rays having entered the diffraction grating 23, only a light ray whose wavelength is determined by a positional relationship between the diffraction grating 23 and the mirror 24 is fed back to the laser diode 21. By way of the lens 22b, the laser diode 21 outputs light having a specific wavelength.

The wavelength of the output light can be changed by means of changing the length of an external cavity through activation of the servomotor 25 for causing the mirror 24 to revolve around a rotation center O.

Because the servomotor 25 is set to merely a predetermined position, a minute error may arise in the position of the mirror 24. For this reason, the servomotor 25 is subjected to drive control, by means of feeding back information about the position of the servomotor 25.

The drive control will now be described by reference to FIG. 2.

FIG. 2 is a view for describing a control operation for changing the position of the mirror 24 shown in FIG. 3 by means of the servomotor 25. The position of the mirror 24 is controlled so as to correspond to the wavelength of output light set by unillustrated setting section, by means of feeding back positional information about the servomotor 25.

Reference numeral 27 designates an LD current circuit for supplying an electric current to the laser diode (LD) 21.

In contrast with the related-art external cavity-type semiconductor laser light source shown in FIG. 3, feedback control operation performed by a servo control circuit 26 shown in FIG. 2 suffers from a problem of internal phase conditions of the tunable laser source failing to be satisfied when a wavelength is changed continually at the time of changing of the wavelength of output light, which in turn results in mode hopping; that is, hopping of a wavelength, and worsens wavelength controllability.

The resonator of the related-art tunable laser source is equipped with a built-in piezoelectric element. The length of the resonator is adjusted by means of utilization of the expansion effect of a piezoelectric element.

### SUMMARY OF THE INVENTION

An object to be addressed by the invention lies in solving, without use of mechanical elements such as piezoelectric elements, the problem of internal phase conditions of the tunable laser source failing to be satisfied when a wavelength is changed continually at the time of changing of the wavelength of output light, which in turn results in mode hopping; that is, hopping of a wavelength, and worsens wavelength controllability.

To solve the problem, there is provided a tunable laser source for continually changing the wavelength of output light by means of changing the length of an external cavity of an external cavity-type semiconductor laser light source section, comprising:

a motor,

a servo control circuit, and

laser diode current control section for controlling a drive current supplied to a laser diode as section for changing the length of the external cavity for preventing occurrence of mode hopping which arises as a result of continual changes in the wavelength of output light. (Aspect 1)

By means of the laser diode current control section, mode hopping, which arises as a result of continual changes in the wavelength of output light, can be prevented by means of adjusting a drive current supplied to the laser diode.

Preferably, an electric current for suppressing mode hopping, which would be caused by variations in the wavelength of output light, is stored in the laser diode current control section in the form of a compensation table corresponding to the wavelength of output light. As a result, occurrence of mode hopping can be readily prevented. (Aspect 2)

Preferably, continual changes in the wavelength of output light, which would change the length of the external cavity, are effected by means of adjusting the position of a mirror constituting the external cavity. As a result, wavelengths in a broad range can be changed continually. Further, there can be prevented occurrence of mode hopping which arises for reasons of “peculiarities” of a mechanical system associated with continual, mechanical changes in wavelength caused by a mirror. (Aspect 3)

Preferably, the position of the mirror is adjusted by means of a servomotor which is controlled by feedback, in response to an instruction output from a wavelength setting section. Consequently, light rays output from respective preset wavelengths can be stabilized. (Aspect 4).

There is also provided a method for preventing occurrence of mode hopping in a tunable laser source which continually changes the wavelength of output light by means of changing the length of an external cavity of an external cavity-type semiconductor laser light source section, the method comprising the steps of:

measuring characteristics of output light when the wavelength of output light is continually changed;

preparing a correction table in which is stored a laser diode drive current for suppressing mode hopping included in characteristics of the output light, so as to correspond to the wavelength of output light; and

driving a laser diode at a current read from the correction table at continual variable output of wavelength of the output light. As a result, there can be prevented occurrence of mode hopping, which would otherwise be caused by continual changes in the wavelength of output light. (Aspect 5)

Preferably, continual variations in the wavelength of output light for changing the length of the external cavity are effected by means of adjusting the position of a mirror constituting the external cavity. As a result, wavelengths in a broad range can be changed continually. Further, there can be prevented occurrence of mode hopping which arises for reasons of “peculiarities” of a mechanical system associated with continual, mechanical changes in wavelength caused by a mirror. (Aspect 6)

### BRIEF DESCRIPTION OF THE DRAWINGS

FIG. 1 is a view showing the configuration of a tunable laser source according to the invention;

FIG. 2 is a view showing the configuration of a related-art tunable laser source;

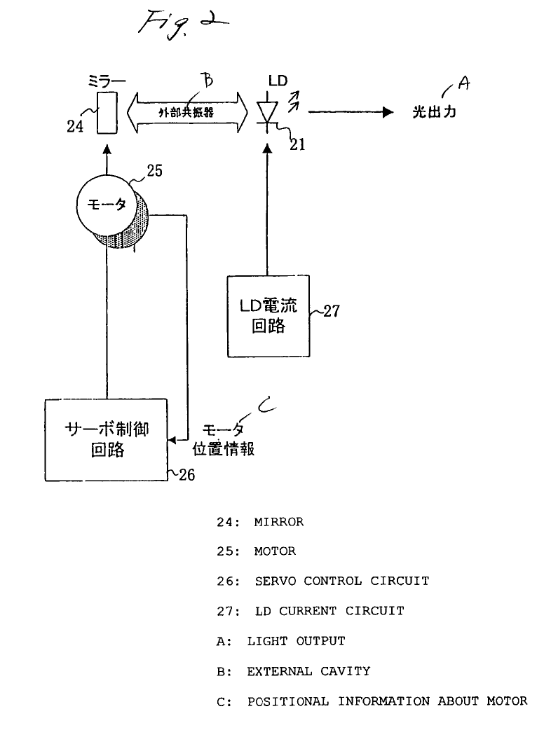

FIG. 3 is a view showing the detailed configuration of a tunable laser source; and

FIGS. 4A to 4C are views for describing prevention of occurrence of mode hopping.

### DETAILED DESCRIPTION OF THE PREFERRED EMBODIMENTS

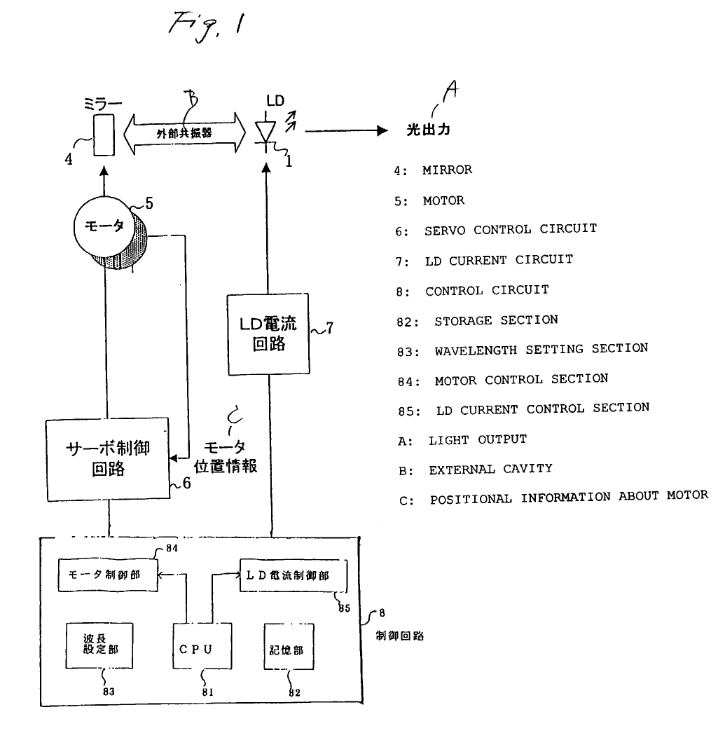

An embodiment of the invention will now be described by reference to FIG. 1.

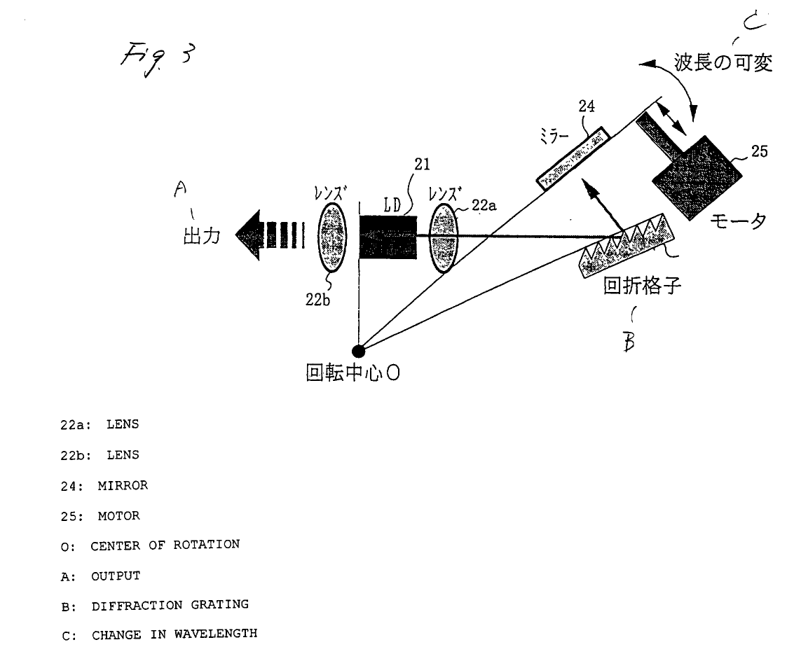

FIG. 1 is a diagram for describing an embodiment of the invention, in which the position of a mirror 4 shown in FIG. 3 is changed by a servomotor 5 and a drive current of a laser diode is controlled.

As shown in FIG. 1, reference numeral 6 designates a servo control circuit for driving and controlling a servomotor 5. The position of the mirror 4 is controlled so as to correspond to the wavelength of the output light set by setting section, by means of feeding back positional information about the servomotor 5.

Reference numeral 7 designates an LD current drive circuit for feeding an electric current to a laser diode (LD) 1.

In accordance with an instruction output from a control circuit 8 to be described later, the LD current drive circuit can change the wavelength of output light by means of adjusting a drive current of the laser diode (LD).

The reason for this is that the internal refractive index of the laser diode is changed as a result of a change in the drive current of the laser diode (LD), thereby changing the length of the entire resonator including an external cavity.

Reference numeral 8 designates a control circuit. The control circuit 8 is constituted of a CPU 81, a storage section 82, a wavelength setting section 83, a motor control section 84, and an LD current control section 85.

The control circuit 8 controls the drive current of the laser diode, as well as changing the position of the mirror 4 under control of the CPU 81 in accordance with the wavelength set by the wavelength setting section 83, by way of the motor control section 84 and the LD current control section 85.

Previously stored in the storage section 82 provided in the control circuit 8 are a first table showing wavelength variations including mode hopping of output light, which would otherwise be caused when the wavelength of output light is continually changed (swept) (the table will hereinafter be called an “output light characteristic table”), and a second table showing a relationship between a drive current to be supplied to the laser diode and the wavelength of output light for preventing occurrence of a mode hopping phenomenon (the table will hereinafter be called a “correction table.”).

When the wavelength of output light is continually changed (swept) by means of the wavelength setting section 83, the control circuit 8 accesses the storage section 82 by way of the CPU 81 for each preset wavelength.

A corresponding laser diode drive current in the correction table of the storage section is read, and the laser diode is driven at the thus-read current. The internal refractive index of the laser diode is changed in response to changes in the drive current supplied to the laser diode (LD) As a result, the length of the entire resonator including an external cavity is changed, thus preventing occurrence of mode hopping.

In order to prevent occurrence of mode hopping, the tunable laser source according to the invention adjusts the length of the resonator by use of the laser diode. The adjustment does not involve any mechanical movement of, e.g., a piezoelectric element. Hence, the tunable laser source according to the invention is superior in response speed and stability to the related-art light source involving mechanical movement.

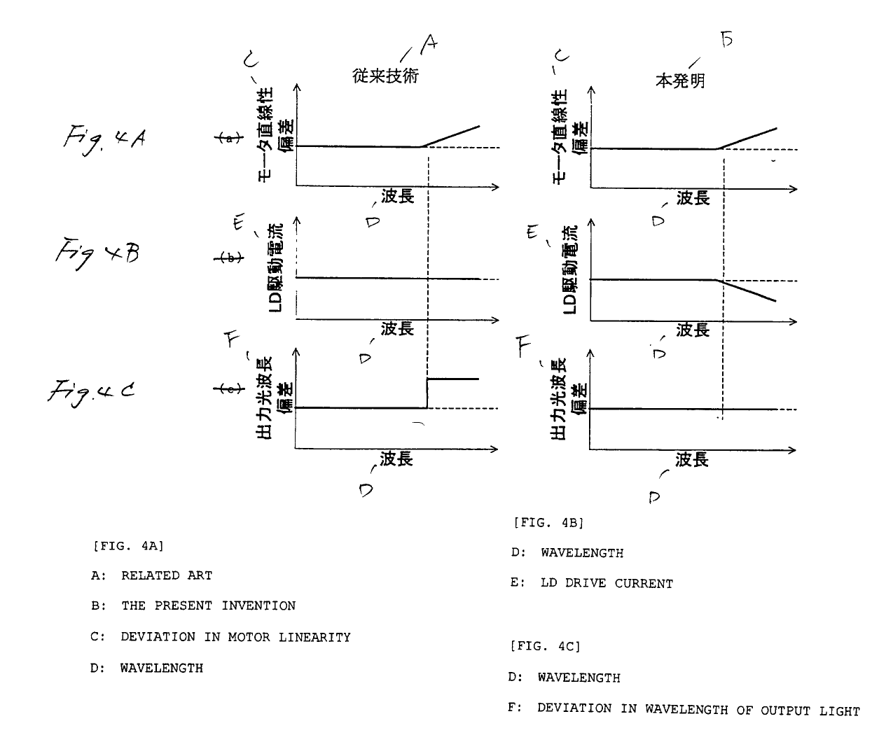

Deviations in the wavelength of output light which arises when the wavelength of output light is continually changed, are schematically depicted in FIG. 4, wherein wavelength deviations in the related-art light source are compared with those in the light source of the invention.

In each of the graphs of FIGS. 4A to 4C, the horizontal axis represents the wavelength of output light. A longitudinal axis provided in FIG. 4A shows deviations in linearity of a motor; that provided in FIG. 4B shows an LD drive current; and that provided in FIG. 4C shows deviations in wavelength of output light.

As shown in FIG. 4A, when deviations in linearity of the motor are not constant with respect to changes in wavelength, the wavelength of output light is changed because of a constant LD drive current employed in the related-art light source, thereby inducing mode hopping.

In contrast, according to the invention, the LD drive current is changed in accordance with variations in deviation of linearity of the motor, and hence deviations in the wavelength of output light are maintained constant, thus preventing occurrence of mode hopping.

According to an invention defined in aspect 1, there is provided a tunable laser source for continually changing the wavelength of output light by means of changing the length of an external cavity of an external cavity-type semiconductor laser light source section, comprising:

laser diode current control section for controlling a drive current supplied to a laser diode as section for changing the length of the external cavity for preventing occurrence of mode hopping which arises as a result of continual changes in the wavelength of output light. Mode hopping which arises as a result of continual changes in the wavelength of output light, can be prevented by means of adjusting a drive current supplied to the laser diode.

According to an invention defined in aspect 2, an electric current for suppressing mode hopping, which would be caused by variations in the wavelength of output light, is stored in the laser diode current control section in the form of a compensation table corresponding to the wavelength of output light. As a result, occurrence of mode hopping can be readily prevented.

According to an invention defined in aspect 3, continual changes in the wavelength of output light, which would change the length of the external cavity, can be effected by means of adjusting the position of a mirror constituting the external cavity. As a result, wavelengths in a broad range can be changed continually. Further, there can be prevented occurrence of mode hopping which arises for reasons of “peculiarities” of a mechanical system associated with continual, mechanical changes in wavelength caused by a mirror.

According to an invention defined in aspect 4, the position of the mirror is adjusted by means of a servomotor which is controlled by feedback, in response to an instruction output from a wavelength setting section. Consequently, light rays output from respective preset wavelengths can be stabilized.

An invention according to aspect 5 provides a method for preventing occurrence of mode hopping in a tunable laser source which continually changes the wavelength of output light by means of changing the length of an external cavity of an external cavity-type semiconductor laser light source section, the method comprising the steps of:

measuring characteristics of output light when the wavelength of output light is continually changed;

preparing a correction table in which is stored a laser diode drive current for suppressing mode hopping included in characteristics of the output light, so as to correspond to the wavelength of output light; and

driving a laser diode at a current read from the correction table at continual variable output of wavelength of the output light. As a result, there can be prevented occurrence of mode hopping, which would otherwise be caused by continual changes in the wavelength of output light.

According to an invention defined in aspect 6, continual variations in the wavelength of output light for changing the length of the external cavity are effected by means of adjusting the position of a mirror constituting the external cavity. As a result, wavelengths in a broad range can be changed continually. Further, there can be prevented occurrence of mode hopping which arises for reasons of “peculiarities” of a mechanical system associated with continual, mechanical changes in wavelength caused by a mirror.

What is claimed is:

1. A tunable laser source for continually changing a wavelength of output light by means of changing a length of an external cavity of an external cavity-type semiconductor laser light source section,
said tunable laser source comprising:
a motor,
a servo control circuit, and
laser diode current control section for controlling a drive current supplied to a laser diode as section for changing the length of said external cavity for preventing occurrence of mode hopping which arises as a result of continual changes in the wavelength of output light.

2. The tunable laser source according to claim 1, wherein
an electric current for suppressing mode hopping, which is caused by variations in the wavelength of output light, is stored in said laser diode current control section in a form of a compensation table corresponding to the wavelength of output light.

3. The tunable laser source according to claim 1, wherein
continual changes in the wavelength of output light, which changes the length of said external cavity, are effected by means of adjusting the position of a mirror constituting said external cavity.

4. The tunable laser source according to claim 1, wherein
the position of said mirror is adjusted by means of a servomotor which is controlled by feedback, in response to an instruction output from a wavelength setting section.

5. A method for preventing occurrence of mode hopping in a tunable laser source which continually changes a wavelength of output light by means of changing a length of an external cavity of an external cavity-type semiconductor laser light source section,
said method comprising the steps of:
measuring characteristics of output light when the wavelength of output light is continually changed;
preparing a correction table in which is stored a laser diode drive current for suppressing mode hopping included in characteristics of the output light, so as to correspond to the wavelength of output light; and
driving a laser diode at a current read from the correction table at continual variable output of wavelength of the output light.

6. The method for preventing occurrence of mode hopping in a tunable laser source according to claim 5, wherein
continual variations in the wavelength of output light for changing the length of said external cavity are effected by means of adjusting the position of a mirror constituting said external cavity.
